(19) United States
(12) Patent Application Publication
(10) Pub. No.: US 2026/0300904 A1
(43) Pub. Date: Oct. 1, 2026

(54) INFORMATION PROCESSING DEVICE, INFORMATION PROCESSING METHOD, AND NON-TRANSITORY COMPUTER-READABLE MEDIUM

(71) Applicant: NEC Corporation, Tokyo (JP)

(72) Inventor: Asako FUJII, Tokyo (JP)

(73) Assignee: NEC Corporation, Tokyo (JP)

(21) Appl. No.: 19/564,370

(22) Filed: Mar. 12, 2026

(30) Foreign Application Priority Data
Mar. 25, 2025 (JP) 2025-049702

(51) Int. Cl. G06Q 10/083

(52) U.S. Cl. CPC G06Q 10/0841

(57) ABSTRACT

An information processing device according to the present disclosure includes a transportation/delivery information acquisition unit that acquires first transportation/delivery information regarding transportation/delivery of a first shipping provider who is entrusted with joint transportation/delivery and second transportation/delivery information regarding transportation/delivery of a second shipping provider who outsources the joint transportation/delivery, a form information acquisition unit that acquires form information regarding a form of the joint transportation/delivery, a transportation/delivery condition output unit that outputs a transportation/delivery condition including the first transportation/delivery information, the second transportation/delivery information, and the form information, an emission information acquisition unit that acquires first emission information regarding a carbon dioxide emission of the first shipping provider and second emission information regarding a carbon dioxide emission of the second shipping provider, the first emission information and the second emission information being estimated based on the transportation/delivery condition, and a provision information output unit that outputs provision information.

### INCORPORATION BY REFERENCE

This application is based upon and claims the benefit of priority from Japanese patent application No. 2025-049702, filed on Mar. 25, 2025, the disclosure of which is incorporated herein in its entirety by reference.

### TECHNICAL FIELD

The present disclosure relates to an information processing device, an information processing method, and a program.

### BACKGROUND ART

In recent years, an approach for reducing carbon dioxide emissions by utilizing joint transportation/delivery has been known. In the joint transportation/delivery, a plurality of shipping providers cooperatively transport and deliver cargos, thereby optimizing the travel distance and loading efficiency of the vehicle and reducing the environmental load. “Transportation/delivery” includes both transportation and delivery. “Transportation” refers to moving a long distance, such as between bases, to carry cargos, and “delivery” refers to moving a short distance, such as between stores, to carry cargos.

As a related technique, Japanese Patent Application Laid-Open No. 2024-142823 discloses a logistics support system that enables selection of a delivery route in consideration of carbon dioxide emissions.

### SUMMARY

In a case where the partner of the joint transportation/delivery is selected, the reduction amount of carbon dioxide to be discharged is one index. In order to evaluate how much carbon dioxide emissions can be reduced by a shipping provider who can be a partner of the joint transportation/delivery, parameters such as a travel distance in transportation/delivery and a weight of cargos to be carried are required. However, at the stage of selecting a partner, since these record values do not exist, it is necessary to calculate an approximate value of the carbon dioxide emission and perform evaluation using the approximate value. The estimated value may deviate from the actual transportation/delivery conditions, and the accuracy may not be sufficient.

In view of the above-described problems, an example object of the present disclosure is to provide an information processing device, an information processing method, and a program capable of accurately estimating a carbon dioxide emission in joint transportation/delivery.

An information processing device according to an example aspect of the present disclosure includes
a transportation/delivery information acquisition unit that acquires first transportation/delivery information regarding transportation/delivery of a first shipping provider who is entrusted with joint transportation/delivery and second transportation/delivery information regarding transportation/delivery of a second shipping provider who outsources the joint transportation/delivery,
a form information acquisition unit that acquires form information regarding a form of the joint transportation/delivery,
a transportation/delivery condition output unit that outputs a transportation/delivery condition including the first transportation/delivery information, the second transportation/delivery information, and the form information,
an emission information acquisition unit that acquires first emission information regarding a carbon dioxide emission of the first shipping provider and second emission information regarding a carbon dioxide emission of the second shipping provider, the first emission information and the second emission information being estimated based on the transportation/delivery condition, and
a provision information output unit that outputs provision information based on the first and second emission information.

An information processing method according to an example aspect of the present disclosure includes
a transportation/delivery information acquisition step of acquiring first transportation/delivery information regarding transportation/delivery of a first shipping provider who is entrusted with joint transportation/delivery and second transportation/delivery information regarding transportation/delivery of a second shipping provider who outsources the joint transportation/delivery,
a form information acquisition step of acquiring form information regarding a form of the joint transportation/delivery,
a transportation/delivery condition output step of outputting a transportation/delivery condition including the first transportation/delivery information, the second transportation/delivery information, and the form information,
an emission information acquisition step of acquiring first emission information regarding a carbon dioxide emission of the first shipping provider and second emission information regarding a carbon dioxide emission of the second shipping provider, the first emission information and the second emission information being estimated based on the transportation/delivery condition, and
a provision information output step of outputting provision information based on the first and second emission information.

A program according to an example aspect of the present disclosure causes a computer to execute
a transportation/delivery information acquisition step of acquiring first transportation/delivery information regarding transportation/delivery of a first shipping provider who is entrusted with joint transportation/delivery and second transportation/delivery information regarding transportation/delivery of a second shipping provider who outsources the joint transportation/delivery,
a form information acquisition step of acquiring form information regarding a form of the joint transportation/delivery,
a transportation/delivery condition output step of outputting a transportation/delivery condition including the first transportation/delivery information, the second transportation/delivery information, and the form information,
an emission information acquisition step of acquiring first emission information regarding a carbon dioxide emission of the first shipping provider and second emission information regarding a carbon dioxide emission of the second shipping provider, the first emission information and the second emission information being estimated based on the transportation/delivery condition, and
a provision information output step of outputting provision information based on the first and second emission information.

The information processing device, the information processing method, and the program according to an example aspect of the present disclosure have an exemplary effect of accurately estimating the carbon dioxide emission in the joint transportation/delivery.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing device according to the present disclosure;

FIG. 2 is a flowchart illustrating a flow of processing performed by the information processing device;

FIG. 3 is a block diagram illustrating a configuration of an information processing system;

FIG. 4 is a diagram illustrating a flow of processing performed by the information processing system;

FIG. 5 is a diagram for explaining consolidation service;

FIG. 6 is a diagram for explaining round transportation;

FIG. 7 is a flowchart illustrating a flow of processing performed by the information processing device;

FIG. 8 is a flowchart illustrating processing performed by the information processing device after joint transportation/delivery is performed;

FIG. 9 is a calculation example in a case where joint transportation/delivery by consolidation service is performed;

FIG. 10 is a calculation example in a case where joint transportation/delivery by round transportation is performed; and

FIG. 11 is a block diagram exemplifying a hardware configuration of a computer that implements the information processing device and the like.

### EXAMPLE EMBODIMENTS

Hereinafter, example embodiments of the present disclosure will be described in detail with reference to the drawings. In the drawings, the same or related elements are denoted by the same reference signs. For clarity of description, redundant description will be omitted as necessary.

### First Example Embodiment

### Information Processing Device 100

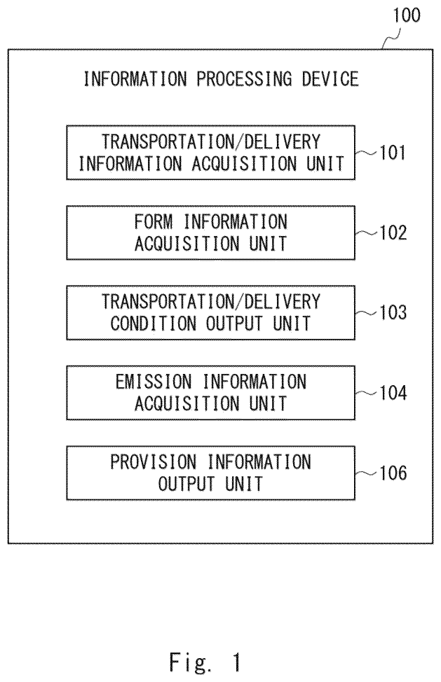

FIG. 1 is a block diagram illustrating a configuration of an information processing device 100 according to the present disclosure. The information processing device 100 includes a transportation/delivery information acquisition unit 101, a form information acquisition unit 102, a transportation/delivery condition output unit 103, an emission information acquisition unit 104, and a provision information output unit 106.

The transportation/delivery information acquisition unit 101 acquires first transportation/delivery information regarding transportation/delivery of a first shipping provider who is entrusted with joint transportation/delivery, and second transportation/delivery information regarding transportation/delivery of a second shipping provider who outsources the joint transportation/delivery. The form information acquisition unit 102 acquires form information regarding a form of joint transportation/delivery. The transportation/delivery condition output unit 103 outputs a transportation/delivery condition including the first transportation/delivery information, the second transportation/delivery information, and the form information.

The emission information acquisition unit 104 acquires first emission information regarding the carbon dioxide emission of the first shipping provider and second emission information regarding the carbon dioxide emission of the second shipping provider, which are estimated based on the transportation/delivery condition. The provision information output unit 106 outputs the provision information based on the first and second emission information.

The information processing device 100 includes a processor, a memory, and a storage device as configurations, not illustrated. The storage device stores a computer program in which the processing according to the present disclosure is implemented. The processor may cause the computer program to be read from the storage device into the memory, and may execute the computer program. As a result, the processor implements the functions of the transportation/delivery information acquisition unit 101, the form information acquisition unit 102, the transportation/delivery condition output unit 103, the emission information acquisition unit 104, and the provision information output unit 106.

Alternatively, each of the transportation/delivery information acquisition unit 101, the form information acquisition unit 102, the transportation/delivery condition output unit 103, the emission information acquisition unit 104, and the provision information output unit 106 may be implemented by dedicated hardware. Some or all of the constituent components may be implemented by general-purpose or dedicated circuitry, a processor, or the like, or a combination thereof. These may be configured by a single chip, or may be configured by a plurality of chips connected via a bus. Some or all of the components may be achieved by a combination of the aforementioned circuitries or the like and the program.

### Processing of Information Processing Device 100

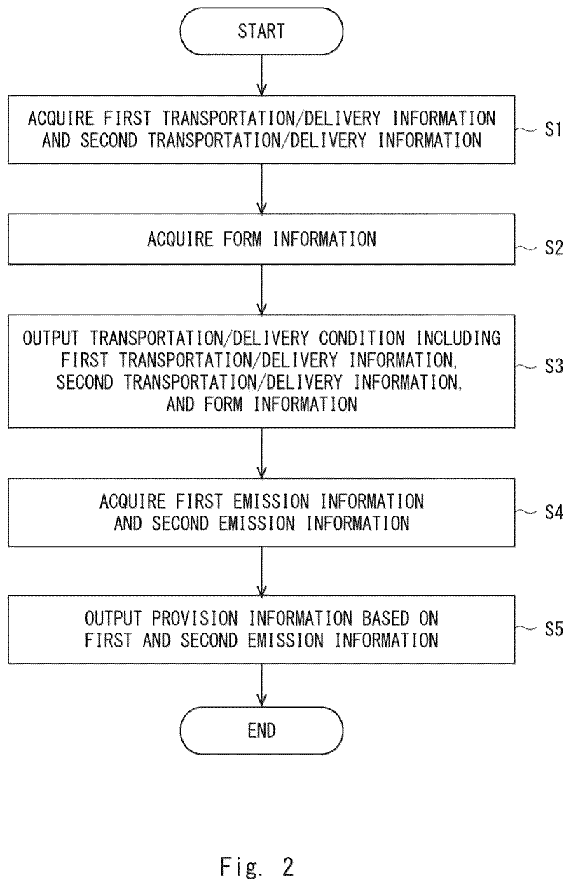

Next, the processing performed by the information processing device 100 will be described with reference to FIG. 2. FIG. 2 is a flowchart illustrating a flow of processing performed by the information processing device 100.

First, the transportation/delivery information acquisition unit 101 acquires the first transportation/delivery information and the second transportation/delivery information (S1). Next, the form information acquisition unit 102 acquires form information (S2). Subsequently, the transportation/delivery condition output unit 103 outputs the transportation/delivery condition including the first transportation/delivery information, the second transportation/delivery information, and the form information (S3). Subsequently, the emission information acquisition unit 104 acquires the first emission information and the second emission information (S4). Then, the provision information output unit 106 outputs the provision information based on the first and second emission information (S5).

As described above, the information processing device 100 according to the present disclosure acquires form information regarding a form of joint transportation/delivery, and acquires information regarding the carbon dioxide emission estimated based on the transportation/delivery condition including the form information. With such a configuration, the information processing device 100 can accurately estimate the carbon dioxide emission in the joint transportation/delivery.

### Second Example Embodiment

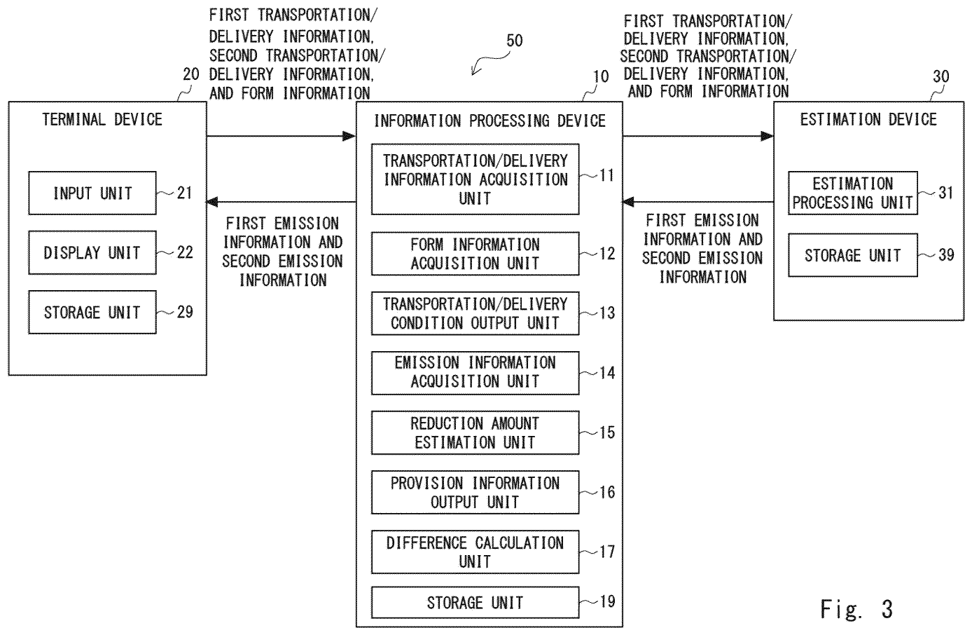

Subsequently, a second example embodiment will be described. The second example embodiment is a specific example of the first example embodiment described above. FIG. 3 is a block diagram illustrating the configuration of an information processing system 50. The information processing system 50 includes an information processing device 10, a terminal device 20, and an estimation device 30. The information processing system 50 is a system capable of processing various types of information regarding the joint transportation/delivery, and estimating a carbon dioxide emission and calculating a reduction amount. The information processing system 50 provides various types of information to a shipping provider who outsources or entrusts the joint transportation/delivery.

The information processing device 10, the terminal device 20, and the estimation device 30 are connected via a network (not illustrated). The network includes, for example, an Internet line, a wireless communication network, or the like, but the type of communication is not limited thereto. The information processing device 10, the terminal device 20, and the estimation device 30 each include a communication unit (not illustrated), and communicate with each other via the network.

The shipping provider is a corporation or an individual that transports and delivers cargos or the like. The shipping provider is, for example, a distribution company, a carrier, a shipper company, or an individual business operator, but is not limited thereto. In the present disclosure, the first and second shipping providers will be used as examples of shipping providers. The first shipping provider is a shipping provider who is entrusted with the joint transportation/delivery. The second shipping provider is a shipping provider who outsources the joint transportation/delivery. Hereinafter, as examples of the first and second shipping providers, a company A and a company B are mainly used. The company A is the first shipping provider, and the company B is the second shipping provider. In a case where the information processing device 10 performs predetermined processing, the company A can select the company B as a consignor for the joint transportation/delivery. The company B can select the company A as a contractor of the joint transportation/delivery.

The terminal device 20 is a terminal device used by each of the company A and the company B. In FIG. 3, the terminal devices 20 used by the company A and the company B are not distinguished from each other, but in the following description, the terminal device 20 used by the company A may be referred to as a terminal device 20A, and the terminal device 20 used by the company B may be referred to as a terminal device 20B. In a case where it is not necessary to particularly distinguish the terminal devices 20A and 20B, they are simply referred to as “terminal device 20” for description. The company A and the company B input necessary information to the information processing device 10 using the terminal devices 20A and 20B used.

The information processing device 10 performs predetermined processing related to the joint transportation/delivery, and outputs information to the terminal devices 20A and 20B of the company A and the company B. The information processing device 10 performs some processing using the estimation device 30. As a result, the company A and the company B acquire information on the joint transportation/delivery. Specifically, the company A and the company B acquire, from the information processing device 10, information serving as a determination material for selecting a shipping provider to be a partner of the joint transportation/delivery.

### Outline of Processing Performed by Information Processing System 50

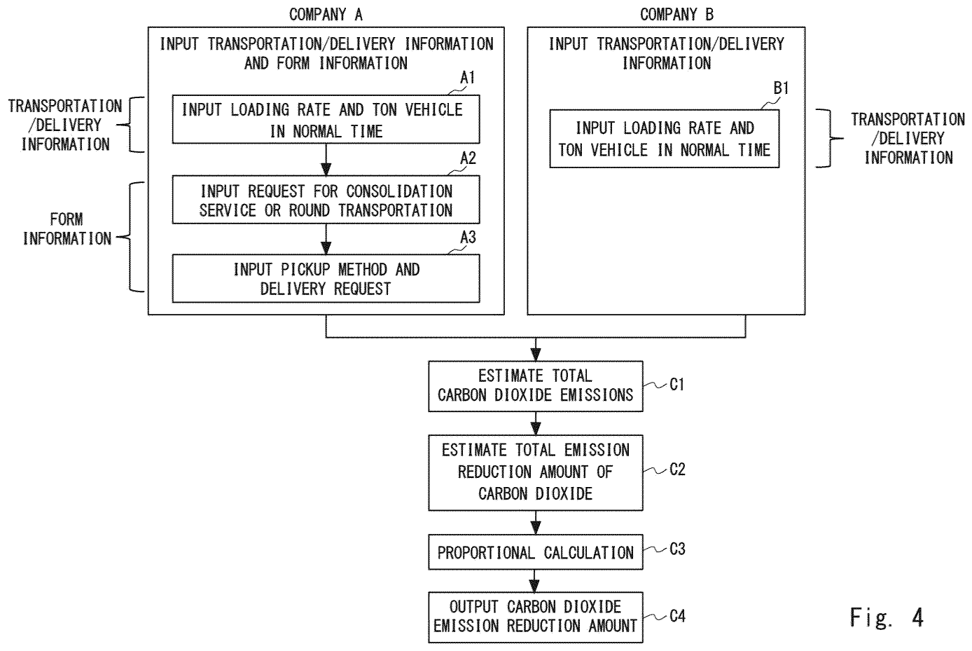

Here, an outline of processing performed by the information processing system 50 will be described with reference to FIG. 4. FIG. 4 is a diagram illustrating a flow of processing performed by the information processing system 50. As illustrated in FIG. 4, the company A inputs transportation/delivery information and form information, and the company B inputs transportation/delivery information. The transportation/delivery information is information regarding transportation/delivery of the company A and the company B. The form information is information regarding a form of the joint transportation/delivery.

First, the company A inputs the loading rate in normal times and information on a ton vehicle to be used (A1). The information input in step A1 is an example of the first transportation/delivery information described above. The “ton vehicle” indicates a vehicle representing loading capacity in units of “ton (t)” among vehicles such as trucks used for transportation/delivery. The ton vehicle is a vehicle classified by the weight of cargo that can be loaded, such as a 2-ton vehicle or a 4-ton vehicle. Therefore, in step A1, the company A inputs information indicating the loading capacity (examples: 2 tons, 4 tons, 10 tons, etc.) of the vehicle used for the joint transportation/delivery.

The loading amount in the normal state indicates the ratio of the cargos actually loaded to the maximum loading capacity of the vehicle. The loading amount may be expressed in percentage (%). For example, in a case where a cargo of 2 tons is loaded on a 4-ton vehicle, the loading rate is 50%. In step A1, the company A inputs a loading rate (examples: 60%, 80%, etc.) during normal operation together with the loading capacity of the vehicle used for the joint transportation/delivery. As the loading rate, for example, an average value, a median value, or the like of actual loading rates within a predetermined period may be used.

Subsequently, the company A inputs a request for consolidation service or round transportation (A2). The consolidation service and the round transportation are examples of transportation/delivery methods. Details of each method will be described later. Furthermore, the company A inputs a request for a pickup method and a delivery method (A3). “Pickup” means collecting cargos (loading cargos on a vehicle) at a departure place of each company. “Delivery” means that cargos are delivered to the arrival place of each company (cargos are unloaded from the vehicle). The pickup method and the delivery method will be described later in detail. The information input in steps A2 and A3 is an example of the form information described above.

Similarly to the company A, the company B inputs the loading rate in normal times and the information on the ton vehicle to be used (B1). The information input in step B1 is an example of the second transportation/delivery information described above.

The information processing device 10 receives information input from the company A and the company B, and performs processing of steps C1 to C4. First, the information processing device 10 estimates the total emission of carbon dioxide based on the information input from the companies A and B (C1).

Specifically, the information processing device 10 estimates the carbon dioxide emission of each company by using the loading rates of the companies A and B during normal operation, the types of the ton vehicles to be used, the travel distances, predetermined coefficients, and the like, and estimates the total emission in consideration of these. The estimated carbon dioxide emission of the company A is an example of the first emission information described above. The estimated carbon dioxide emission of the company B is an example of the second emission information described above.

More specifically, the information processing device 10 can estimate the carbon dioxide emission using the following Expression (1) based on the improved ton kilometer.

$$Carbon dioxide emission \approx weight of cargo \times travel distance \times ( improved ton kilometer method duel consumption basic unit ( L / ( t \cdot km ) ) \times carbon dioxide emission coefficient \times ( 1 / 1000 ) \qquad Expression ( 1 )$$

Here, the “improved ton kilometer method fuel consumption basic unit (L/(t·km))” indicates the fuel consumption per unit transportation amount. The carbon dioxide emission coefficient indicates the carbon dioxide emission amount per unit fuel.

By expressing the weight of the cargo by the loading rate and the loading capacity of the ton vehicle, Expression (1) can be approximated as the following Expression (2).

$$Carbon dioxide emission \approx loading rate \times ton vehicle \times travel distance \times constant \qquad Expression ( 2 )$$

The information processing device 10 estimates the carbon dioxide emission for each form of the joint transportation/delivery by applying Expression (1) or Expression (2), and compares the emission in a case where the joint transportation/delivery is performed with the emission in a case where the joint transportation/delivery is not performed.

Next, the information processing device 10 estimates a total emission reduction amount of carbon dioxide (C2). Specifically, the information processing device 10 further acquires third emission information regarding the carbon dioxide emission of the company A in a case where the joint transportation/delivery is not performed and fourth emission information regarding the carbon dioxide emission of the company B in this case, and estimates the total emission reduction amount of carbon dioxide based on the first to fourth emission information.

Subsequently, the information processing device 10 performs a proportion calculation on the estimated total emission reduction amount of carbon dioxide (C3). In this proportion calculation, the estimated total emission reduction amount of carbon dioxide is distributed to each company based on the transportation distance and the loading ratio of the companies A and B.

Finally, the information processing device 10 outputs the carbon dioxide emission reduction amount of each company after proportional distribution (C4). The carbon dioxide emission reduction amount of each company after proportional distribution is an example of the provision information described above. The information processing device 10 can provide information to the company A and the company B by displaying the emission reduction amount on a display unit such as a display. As a result, the company A and the company B can confirm the carbon dioxide emission reduction effect in the case of the joint transportation/delivery. The company A can consider whether to select the company B as a partner of the joint transportation/delivery, and the company B can consider whether to select the company A as a partner of the joint transportation/delivery.

Here, an example in which the company A inputs the transportation/delivery information and the form information and the company B inputs the transportation/delivery information has been described, but the present disclosure is not limited thereto. The company B may input the transportation/delivery information and the form information, and the company A may input the transportation/delivery information. The company B can acquire information of a partner that can satisfy the desires by inputting the desires of the desired transportation/delivery method, pickup method, and delivery method.

Here, the description has been made using only the company A and the company B, but the information processing device 10 may perform similar processing on three or more shipping providers. For example, the company A can select a partner by confirming an effect of reducing carbon dioxide emissions with a plurality of candidate shipping providers.

### Information Processing Device 10

Returning to FIG. 3, the configuration of each device will be described. The information processing device 10 is an example of the information processing device 100 described above. The information processing device 10 includes a transportation/delivery information acquisition unit 11, a form information acquisition unit 12, a transportation/delivery condition output unit 13, an emission information acquisition unit 14, a reduction amount estimation unit 15, a provision information output unit 16, a difference calculation unit 17, and a storage unit 19. The information processing device 10 can be configured by, for example, a server device or the like.

The transportation/delivery information acquisition unit 11 is an example of the transportation/delivery information acquisition unit 101 described above. The transportation/delivery information acquisition unit 11 acquires first transportation/delivery information regarding transportation/delivery of the company A (first shipping provider) who is entrusted with joint transportation/delivery, and second transportation/delivery information regarding transportation/delivery of the company B (second shipping provider) who outsources the joint transportation/delivery.

The first transportation/delivery information is information regarding transportation/delivery of the company A, and the second transportation/delivery information is information regarding transportation/delivery of the company B. For example, the first transportation/delivery information may include information on a first departure and arrival place which is a departure and arrival place of the company A. The second transportation/delivery information may include information on a second departure and arrival place which is a departure and arrival place of the company B.

The information on the first departure and arrival place, which is the departure and arrival place of the company A, is information indicating a base where the company A loads or unloads cargo. The information may be, for example, address or position information of a distribution center, a warehouse, a store, a factory, or the like where the company A sends or receives the cargo. Similarly, the information on the second departure and arrival place, which is the departure and arrival place of the company B, is information indicating a base where the company B loads or unloads cargo. The information may be, for example, an address or position information of a distribution center or the like where the company B sends or receives cargo.

The first transportation/delivery information may include information regarding the weight of the cargo of the company A. Similarly, the second transportation/delivery information may include information regarding the weight of the company B's cargo. The information regarding the weight of the cargo of the company A is, for example, information indicating the loading rate of the vehicle used by the company A in the normal time and the vehicle type (for example, tonnage) of the vehicle used by the company A in the normal time. Similarly, the information regarding the weight of the cargo of the company B is, for example, information indicating the loading rate of the vehicle used by the company B in the normal time and the vehicle type (for example, tonnage) of the vehicle used by the company B in the normal time.

The form information acquisition unit 12 is an example of the form information acquisition unit 102 described above. The form information acquisition unit 12 acquires form information regarding a form of joint transportation/delivery. The form information is information indicating a form in which the joint transportation/delivery is performed. The form information includes, for example, information on the transportation/delivery method between the first departure and arrival place and the second departure and arrival place.

The transportation/delivery method indicates how to transport and deliver the cargos of the company A and the company B. Examples of the transportation/delivery method include consolidation service and round transportation. The consolidation service is a system in which a cargo of the company A and a cargo of the company B are simultaneously loaded on one vehicle and transported and delivered. The round transportation is a method in which one vehicle transports and delivers a cargo of the company A on the outward way and transports and delivers a cargo of the company B on the return way, thereby improving the efficiency of reciprocating transportation/delivery.

The form information may further include information regarding a cargo pickup method and delivery method at each of the first and second departure and arrival places. As cargo pickup methods, there are “picking up” in which the company A goes to the base of the company B and picks up cargo, and “bringing” in which the company B brings cargo to the base of the company A. As cargo delivery methods, there are “bringing” in which the company A goes to the base of the company B and delivers the cargo and “picking up” in which the company B goes to the base of the company A and picks up the cargo. Since the travel distance and the loading state of the vehicle in the joint transportation/delivery differ depending on the cargo pickup method and delivery method, the estimated carbon dioxide emission also differs. The bases of the company A and the company B are departure and arrival places in the joint transportation/delivery. The departure and arrival place may be, for example, a facility such as a distribution center, a warehouse, a store, or a factory. Next, consolidation service and round transportation will be described.

### Consolidation Service

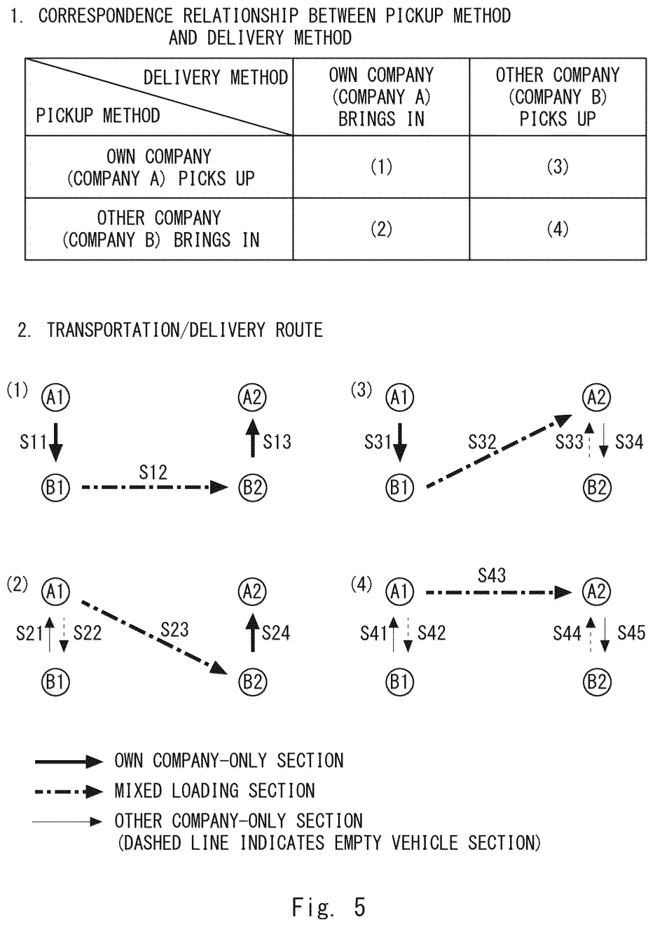

FIG. 5 is a diagram for explaining consolidation service. The upper part of FIG. 5 illustrates a correspondence relationship between the pickup method and the delivery method in the transportation/delivery routes of (1) to (4) illustrated in the lower part of FIG. 5. The lower part of FIG. 5 illustrates a specific transportation/delivery route in a case where the company A performs the joint transportation/delivery with the company B by consolidation service. A1, A2, B1, and B2 indicate bases of the company A and the company B. A1 and A2 are a departure point and an arrival point of the company A. B1 and B2 are a departure point and an arrival point of the company B. The movement of the vehicle in each case will be described below. In the following description, description will be made mainly based on the company A. Therefore, the company A will be referred to as “own company”, and the company B will be referred to as “other company”.

The thick solid line in FIG. 5 indicates movement in the “own company-only section” in which only the own company's (company A) cargo is carried. The thick dashed-dotted line indicates the movement in the “mixed loading section” where the cargos of the companies A and B are loaded. The thin solid line indicates the movement in the “other company-only section” in which only the cargo of other company (company B) is carried. The thin broken line indicates an empty vehicle section where no cargo is placed on the vehicle. These line types are common to the following drawings.

### Case of (1)

S11: The company A's vehicle moves from A1 to B1. The company A's vehicle is loaded with the cargo of the company A. The company A's vehicle picks up the company B's cargo at B1.

S12: The company A's vehicle moves from B1 to B2. The company A's vehicle is loaded with the cargos of the company A and the company B. The company A's vehicle brings the company B's cargo to B2.

S13: The company A's vehicle moves from B2 to A2. The company A's vehicle is loaded with the cargo of the company A. The company A's vehicle brings the company A's cargo to A2.

### Case of (2)

S21: The company B's vehicle moves from B1 to A1. The company B's vehicle is loaded with the company B's cargo. The company B's vehicle brings the company B's cargo to A1.

S22: The company B's vehicle returns from A1 to B1. The company B's vehicle is empty.

S23: The company A's vehicle moves from A1 to B2. The company A's vehicle is loaded with the cargos of the company A and the company B. The company A's vehicle brings the company B's cargo to B2.

S24: The company A's vehicle moves from B2 to A2. The company A's vehicle is loaded with the cargo of the company A. The company A's vehicle brings the company A's cargo to A2.

### Case of (3)

S31: The company A's vehicle moves from A1 to B1. The company A's vehicle is loaded with the cargo of the company A. The company A's vehicle picks up the company B's cargo at B1.

S32: The company A's vehicle moves from B1 to A2. The company A's vehicle is loaded with the cargos of the company A and the company B. The company A's vehicle brings the company A's cargo to A2.

S33: The company B's vehicle moves from B2 to A2. The company B's vehicle is empty. The company B's vehicle picks up the company B's cargo at A2.

S34: The company B's vehicle returns from A2 to B2. The company B's vehicle is loaded with the company B's cargo. The company B's vehicle brings the company B's cargo to B2.

### Case of (4)

S41: The company B's vehicle moves from B1 to A1. The company B's vehicle is loaded with the company B's cargo. The company B's vehicle brings the company B's cargo to A1.

S42: The company B's vehicle returns from A1 to B1. The company B's vehicle is empty.

S43: The company A's vehicle moves from A1 to A2. The company A's vehicle is loaded with the cargos of the company A and the company B. The company A's vehicle brings the company A's cargo to A2.

S44: The company B's vehicle moves from B2 to A2. The company B's vehicle is empty. The company B's vehicle picks up the company B's cargo at A2.

S45: The company B's vehicle returns from A2 to B2. The company B's vehicle is loaded with the company B's cargo. The company B's vehicle brings the company B's cargo to B2.

### Round Transportation

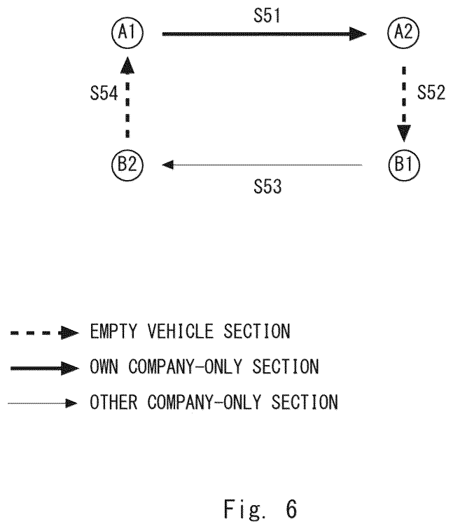

FIG. 6 is a diagram for explaining round transportation. The movement of the vehicle will be described in the same manner as in the lower part of FIG. 5.

S51: The company A's vehicle moves from A1 to A2. The company A's vehicle is loaded with the cargo of the company A. The company A's vehicle brings the company A's cargo to A2.

S52: The company A's vehicle moves from A2 to B1. The company A's vehicle is empty. The company A's vehicle picks up the company B's cargo at B1.

S53: The company A's vehicle moves from B1 to B2. The company A's vehicle is loaded with the company B's cargo. The company A's vehicle brings the company B's cargo to B2.

S54: The company A's vehicle moves from B2 to A1. The company A's vehicle is empty.

Returning to FIG. 3, the description of the form information acquisition unit 12 will be continued. The form information acquisition unit 12 acquires a form of the joint transportation/delivery designated by the company A or the company B as form information in a joint transportation/delivery system (not illustrated) that adjusts the joint transportation/delivery between shipping providers. The joint transportation/delivery system is a system that matches a partner of the joint transportation/delivery suitable for a transportation/delivery condition among a plurality of shipping providers. For example, the company A or the company B operates the terminal device 20A or 20B, and designates the transportation delivery method, the pickup method, and the delivery method used for the joint transportation/delivery via the input screen provided by the joint transportation/delivery system.

The transportation/delivery condition output unit 13 is an example of the transportation/delivery condition output unit 103 described above. The transportation/delivery condition output unit 13 outputs a transportation/delivery condition including the first transportation/delivery information, the second transportation/delivery information, and the form information. For example, the transportation/delivery condition output unit 13 transmits the transportation/delivery condition including the first and second transportation/delivery information acquired by the transportation/delivery information acquisition unit 11 and the form information acquired by the form information acquisition unit 12 to the estimation device 30.

As a result, the transportation/delivery condition output unit 13 requests the estimation device 30 to estimate the emission information of each of the company A and the company B. In this way, the information processing device 10 can acquire the estimation results of the emission information of each of the company A and the company B from the estimation device 30.

Although the example in which the estimation device 30 estimates the emission information has been described here, the present disclosure is not limited thereto. The transportation/delivery condition output unit 13 may output the transportation/delivery condition to a device other than the estimation device 30. For example, in a case where the information processing device 10 includes an emission information estimation unit that estimates emission information, the transportation/delivery condition output unit 13 may output the transportation/delivery condition to the emission information estimation unit.

The transportation/delivery condition may include information regarding a distance between the first and second departure and arrival place, a type of vehicle used for transportation/delivery, a loading rate, or the like. The distance between the first and second departure and arrival places can be calculated using map information or a route search service based on, for example, an address or position information of each of the departure and arrival places. The type of vehicle is, for example, information regarding the tonnage and vehicle type of the vehicle used for transportation/delivery. The information regarding the loading rate is, for example, information indicating a ratio of the weight of the cargo loaded on the vehicle at the time of transportation/delivery to the maximum loadable weight of the vehicle.

As the information to be provided to the estimation device 30, for example, record values of transportation/delivery record data and emission information acquired in the past may be added. Furthermore, external data such as road information and traffic information may be added.

The emission information acquisition unit 14 is an example of the emission information acquisition unit 104 described above. The emission information acquisition unit 14 acquires first emission information regarding the carbon dioxide emission of the company A (first shipping provider) and second emission information regarding the carbon dioxide emission of the company B (second shipping provider), which are estimated based on the transportation/delivery condition. The emission information acquisition unit 14 acquires the first and second emission information from the estimation device 30. The first and second emission information may be estimated by a predetermined calculation formula in the estimation device 30, or may be estimated using an estimation model or the like stored in the estimation device 30.

The estimation model is, for example, a trained model learned so as to output an estimated carbon dioxide emission in a case where information such as a loading rate, a type of a ton vehicle, and a travel distance is input as a transportation/delivery condition. The estimation device 30 can estimate the carbon dioxide emission relevant to the new transportation/delivery condition by using this estimation model. Any technique can be used for learning the estimation model. For example, a machine learning method such as a neural network may be used.

The emission information acquisition unit 14 may further acquire third emission information regarding the carbon dioxide emission of the company A and fourth emission information regarding the carbon dioxide emission of the company B in a case where the joint transportation/delivery is not performed. The emission information acquisition unit 14 may acquire these pieces of information by calculation or may acquire a calculation result in the estimation device 30.

Based on the first to fourth emission information, the reduction amount estimation unit 15 estimates an emission reduction amount that is a difference between the carbon dioxide emission in a case where the joint transportation/delivery is performed and the carbon dioxide emission in a case where the joint transportation/delivery is not performed. The emission reduction amount indicates the carbon dioxide emission amount reduced by implementation of the joint transportation/delivery. The reduction amount estimation unit 15 estimates the emission reduction amount by subtracting the emission in the case of performing the joint transportation/delivery from the emission in the case of not performing the joint transportation/delivery. By estimating the emission reduction amount, the environmental load reduction effect of the joint transportation/delivery can be quantitatively evaluated.

In a case where there is a plurality of candidate shipping providers who are candidates for the partner of the joint transportation/delivery of the company A or the company B, the reduction amount estimation unit 15 estimates the emission reduction amount of each of the plurality of candidate shipping providers. The candidate shipping provider indicates a shipping provider who can be selected as the second shipping provider in the joint transportation/delivery entrusted to the first shipping provider, and a shipping provider who can be selected as the first shipping provider in the joint transportation/delivery outsourced by the second shipping provider.

The candidate shipping provider in the joint transportation/delivery entrusted to the first shipping provider may be specified from, for example, a shipping provider having a base close to the base of the first shipping provider, a shipping provider who has performed the joint transportation/delivery with the first shipping provider in the past, or a shipping provider whose transportation/delivery route overlaps with the transportation/delivery route of the first shipping provider. Similarly, the candidate shipping provider in the joint transportation/delivery outsourced by the second shipping provider may be specified from, for example, a shipping provider having a base close to the base of the second shipping provider, a shipping provider who has performed the joint transportation/delivery with the second shipping provider in the past, or a shipping provider whose transportation/delivery route overlaps with the transportation/delivery route of the second shipping provider.

For example, in a case where there are a company B, a company C, and a company D as the candidate shipping providers of the company A, the reduction amount estimation unit 15 estimates the emission reduction amounts of the company B, the company C, and the company D. The reduction amount estimation unit 15 calculates a carbon dioxide emission in a case where the joint transportation/delivery with the company A is performed for each candidate shipping provider, and compares the carbon dioxide emission with the carbon dioxide emission in a case where the joint transportation/delivery is not performed, thereby estimating the emission reduction amount by the joint transportation/delivery with each candidate shipping provider.

The provision information output unit 16 is an example of the provision information output unit 106 described above. The provision information output unit 16 outputs the provision information based on the first and second emission information. The provision information is information provided to persons involved in the joint transportation/delivery.

For example, the provision information output unit 16 may include a display device such as a display. The provision information output unit 16 causes the display device to display the provision information. As a result, a person who looks at the display can confirm the provision information.

The provision information output unit 16 may output the provision information including the emission reduction amount. The provision information output unit 16 may output the provision information including the first and second emission information.

The provision information output unit 16 can output the provision information in any output mode. For example, the provision information output unit 16 may output the provision information to the terminal device 20A used by the company A. As a result, the provision information is displayed on a display unit 22 of the terminal device 20A. The provision information output unit 16 may output the provision information to the terminal device 20B used by the company B. As a result, the provision information is displayed on the display unit 22 of the terminal device 20B. The output mode is not limited thereto. The provision information output unit 16 may output the provision information to a PC, a display device, an external system, or the like.

In a case where there is a plurality of candidate shipping providers who are candidates for the partner of the joint transportation/delivery, the provision information output unit 16 may output the provision information by rearranging the candidate shipping providers based on the emission reduction amount. For example, the provision information output unit 16 may rearrange the candidate shipping providers in descending order of the emission reduction amount. The provision information output unit 16 may output only the candidate shipping provider with a higher emission reduction amount. For example, it is assumed that there are a company B, a company C, and a company D as the candidate shipping providers of the company A. In a case where the company B, the company D, and the company C are arranged in this order of magnitude of the emission reduction amount, the provision information output unit 16 may output the provision information so that the company B, the company D, and the company C are displayed in this order from the top, or may output the provision information so that only the higher company B and company D are displayed.

The provision information output unit 16 may output the provision information to a plurality of candidate shipping providers. For example, the provision information output unit 16 may output, to the terminal device 20B of the company B, that there are three companies of the company B, the company C, and the company D as the candidate shipping providers of the company A. By doing so, the company B can grasp that there are other candidate shipping providers regarding the joint transportation/delivery with the company A. In this case, the provision information output unit 16 may output the provision information including the emission reduction amount, the order thereof, and the like.

The difference calculation unit 17 acquires first record information indicating a record for the estimated first emission information and second record information indicating a record for the estimated second emission information after execution of the joint transportation/delivery. The first and second record information may be calculated values or actual measurement values.

For example, the difference calculation unit 17 calculates the carbon dioxide emission in consideration of the travel distance and the loading rate based on the transportation/delivery conditions. The difference calculation unit 17 acquires a calculated value by the calculation as a record value after implementation of the joint transportation/delivery.

The difference calculation unit 17 may acquire data from a sensor that measures a fuel consumption amount or a travel distance of the vehicle, or transportation record data from an external transportation/delivery management system or the like, and calculate an actual measurement value based on the transportation record data. The difference calculation unit 17 acquires the actual measurement value as a record value after implementation of the joint transportation/delivery.

The difference calculation unit 17 calculates a difference between the estimated value in the first emission information and the record value in the first record information by comparing the estimated value with the record value in the first record information. In a case where the partner of the joint transportation/delivery is determined and the joint transportation/delivery is actually performed, the record data of the joint transportation/delivery is accumulated, and the actual measurement value of the carbon dioxide emission can be acquired. By utilizing this actual measurement value, it is possible to improve the accuracy of carbon dioxide emission estimation and to optimize a future transportation/delivery plan.

Specifically, the difference calculation unit 17 compares the estimated value of the carbon dioxide emission calculated in a case where the partner of the joint transportation/delivery is selected with the actual measurement value acquired after the joint transportation/delivery is performed. As a result, the difference calculation unit 17 can evaluate the accuracy of the provisional value. For example, the difference calculation unit 17 analyzes an error between the estimated value and the actual measurement value and grasps a tendency of the error to correct the influence of the difference in the transportation/delivery conditions. As a result, a more accurate estimation model can be constructed.

The difference calculation unit 17 may perform feedback on the estimation model based on the actual measurement value. As a result, it is possible to improve the accuracy of the emission evaluation at the planning stage of transportation/delivery, and thus, it is possible to select a more appropriate joint transportation/delivery partner and propose an optimal joint transportation/delivery form.

The information processing device 10 may perform relearning of the estimation model for estimating the first and second emission information by using the calculated difference. For example, the information processing device 10 transmits difference information regarding the difference calculated by the difference calculation unit 17 to the estimation device 30. The difference information is input as training data of the estimation model in the estimation device 30. The estimation device 30 updates the parameter of the estimation model using the difference information and the actual measurement value. As a result, the estimation device 30 can improve the accuracy of the emission estimation.

The information processing device 10 estimates the newly acquired first and second emission information by using the estimation model relearned by the estimation device 30, and outputs the estimation result. For example, in a case where artificial intelligence (AI) is used in the estimation of the first and second emission information, the information processing device 10 can improve the estimation accuracy by using the difference information and the past transportation/delivery information as the training data.

The storage unit 19 stores various data and programs. At least a part of the storage unit 19 is configured by a non-volatile memory in such a way that the data is retained even if the power supply of the information processing device 10 is turned off. The storage unit 19 may store various types of information acquired or the like by each functional unit of the transportation/delivery information acquisition unit 11, the form information acquisition unit 12, the transportation/delivery condition output unit 13, the emission information acquisition unit 14, the reduction amount estimation unit 15, the provision information output unit 16, and the difference calculation unit 17.

### Terminal Device 20

The terminal device 20 is a device for inputting the first or second transportation/delivery information and the form information. The terminal device 20 includes an input unit 21, a display unit 22, and a storage unit 29. For example, the terminal device 20A used by the company A inputs the first transportation/delivery information and the form information. The terminal device 20B used by the company B inputs the second transportation/delivery information. The terminal device 20 may output various types of information. The terminal device 20 may include, for example, a personal computer (PC), a smartphone, a tablet terminal, or the like.

The input unit 21 is an input device for the user to input transportation/delivery information and form information. The user may be, for example, a person in charge or an administrator of the company A or the company B. The input unit 21 receives a user's input. The input unit 21 may be, for example, a mouse, a keyboard, or the like. The input unit 21 may be a touch panel having the function of the display unit 22.

The display unit 22 is a display device that displays various types of information. The display unit 22 is, for example, a display. The display unit 22 may be a touch panel having the function of the input unit 21. The display unit 22 displays, for example, provision information provided to the company A or the company B. Although not illustrated, the terminal device 20 may include a voice output unit that outputs the provision information by voice.

The storage unit 29 stores various data and programs. At least a part of the storage unit 29 is configured by a non-volatile memory in such a way that the data is retained even if the power supply of the terminal device 20 is turned off. The storage unit 29 may store provision information and the like.

### Estimation Device 30

The estimation device 30 is a device that estimates the carbon dioxide emission based on the transportation/delivery condition output from the information processing device 10. The estimation device 30 includes an estimation processing unit 31 and a storage unit 39. The transportation/delivery condition includes first transportation/delivery information, second transportation/delivery information, and form information. The estimation device 30 can include, for example, a server device different from the information processing device 10.

The estimation processing unit 31 performs estimation processing of outputting the estimated carbon dioxide emission with the transportation/delivery condition as an input. The estimation processing unit 31 may perform estimation using a predetermined calculation formula or may perform estimation using an estimation model utilizing AI.

The storage unit 39 stores various data and programs. At least a part of the storage unit 39 is configured by a non-volatile memory in such a way that the data is retained even if the power supply of the estimation device 30 is turned off. The storage unit 39 may store an estimation model for estimating the first and second emission information.

Heretofore, the configuration included in the information processing system 50 has been described. The above-described configuration of the information processing system 50 is merely an example, and can be appropriately changed. For example, in a case where some or all of the components of the information processing system 50 are achieved by a plurality of information processing devices, circuits, and the like, the plurality of information processing devices, circuits, and the like may be disposed in a centralized manner or in a distributed manner. For example, each of the information processing devices, circuitry, and the like may be implemented in the form of a client server system, a cloud computing system, or the like in which they are connected to each other through a communication network. The functions of the information processing device 10, the terminal device 20, and the estimation device 30 may be provided in the form of software as a service (SaaS).

For example, in the above description, the storage unit 19 is illustrated inside the information processing device 10 in FIG. 3, but the storage unit 19 may be provided outside the information processing device 10. The same applies to the storage unit 29 of the terminal device 20 and the storage unit 39 of the estimation device 30.

### Processing of Information Processing Device 10

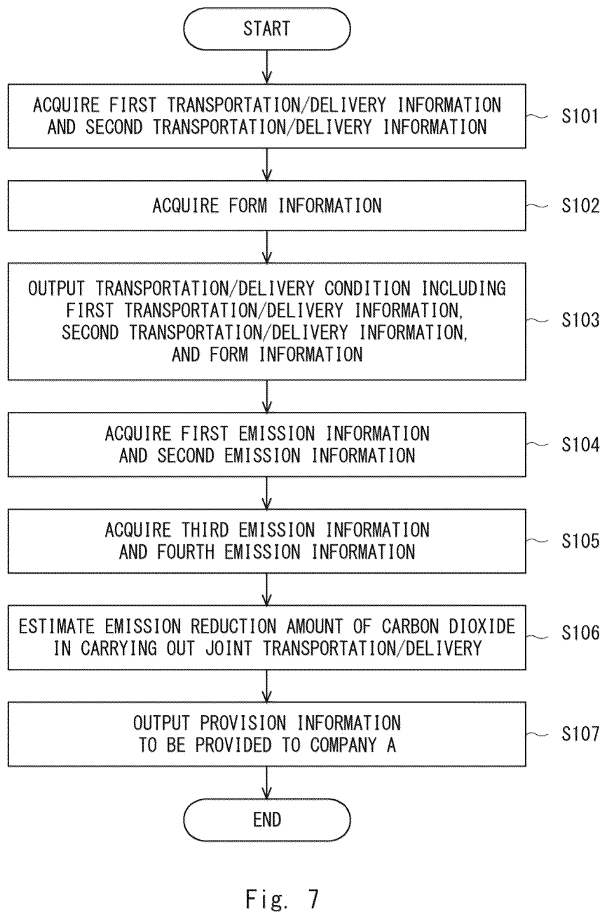

Next, the process performed by the information processing device 10 will be described with reference to FIG. 7. FIG. 7 is a flowchart illustrating a flow of processing performed by the information processing device 10. Hereinafter, a description will be given using an example in which the first shipping provider who is entrusted with the joint transportation/delivery is a company A, the second shipping provider who outsources the joint transportation/delivery is a company B, and the company A selects a consignor. In a case where the company B selects a contractor, the description can be made by replacing the company A with the company B.

First, the transportation/delivery information acquisition unit 11 acquires first transportation/delivery information regarding transportation/delivery of the company A and second transportation/delivery information regarding transportation/delivery of the company B (S101). For example, the first transportation/delivery information may include information on a first departure and arrival place, which is a departure and arrival place of the company A, and information on a weight of a cargo of the company A. The second transportation/delivery information may include information on a second departure and arrival place, which is a departure and arrival place of the company B, and information on a weight of a cargo of the company B.

Next, the form information acquisition unit 12 acquires form information regarding the form of the joint transportation/delivery of the company A and the company B (S102). For example, the form information includes information on the transportation/delivery method between the first departure and arrival place and the second departure and arrival place. The form information may further include information regarding a cargo pickup method and delivery method at each of the first and second departure and arrival places.

Subsequently, the transportation/delivery condition output unit 13 outputs the transportation/delivery condition including the first transportation/delivery information, the second transportation/delivery information, and the form information (S103). Here, it is assumed that the transportation/delivery condition output unit 13 outputs the transportation/delivery condition to the estimation device 30. The emission information acquisition unit 14 acquires, from the estimation device 30, the first emission information regarding the carbon dioxide emission of the company A and the second emission information regarding the carbon dioxide emission of the company B estimated based on the transportation/delivery conditions (S104).

The emission information acquisition unit 14 further acquires third emission information regarding the carbon dioxide emission of the company A and fourth emission information regarding the carbon dioxide emission of the company B in a case where the joint transportation/delivery is not performed (S105). Based on the first to fourth emission information, the reduction amount estimation unit 15 compares the carbon dioxide emission in the case of performing the joint transportation/delivery with the carbon dioxide emission in the case of not performing the joint transportation/delivery, and estimates the carbon dioxide emission reduction amount due to the implementation of the joint transportation/delivery (S106).

Subsequently, the provision information output unit 16 outputs the provision information to be provided to the company A (S107). For example, the provision information output unit 16 outputs the provision information to the terminal device 20A used by the company A. The provision information output unit 16 may include a carbon dioxide emission reduction amount and the like in the provision information. As a result, the company A can grasp the carbon dioxide emission reduction amount and the like in the joint transportation/delivery with the company B. The provision information output unit 16 may also output the provision information to the terminal device 20B of the company B. In a case where there is a candidate shipping provider of the company A other than the company B, the provision information output unit 16 may output the provision information by rearranging the candidate shipping provider based on the emission reduction amount of each candidate shipping provider.

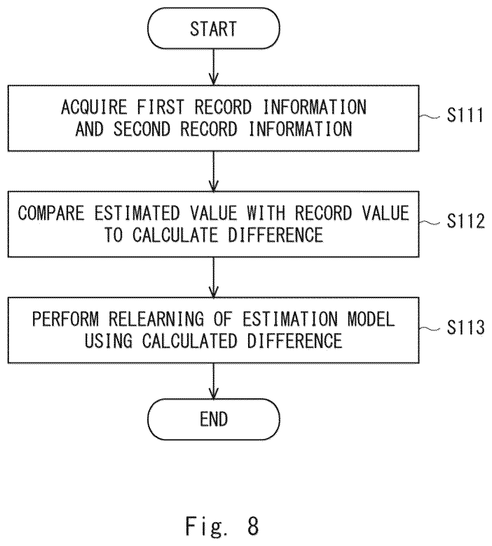

FIG. 8 is a flowchart illustrating processing performed by the information processing device 10 after joint transportation/delivery is performed. First, the difference calculation unit 17 acquires first record information indicating a record for the estimated first emission information and second record information indicating a record for the estimated second emission information (S111). The first and second record information may be calculated values or actual measurement values.

Next, the difference calculation unit 17 calculates the difference between the estimated value and the record value by comparing the estimated value with the record value (S112). The difference calculation unit 17 performs relearning of the estimation model used in the estimation device 30 by using the calculated difference (S113). The difference calculation unit 17 performs feedback on the estimation model of the estimation device 30. As a result, the accuracy of the emission evaluation at the planning stage of transportation/delivery can be improved.

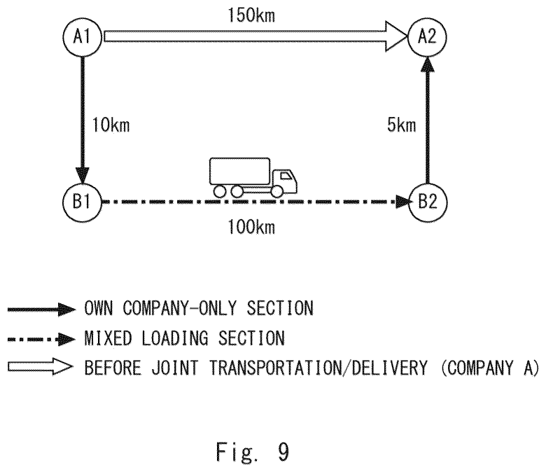

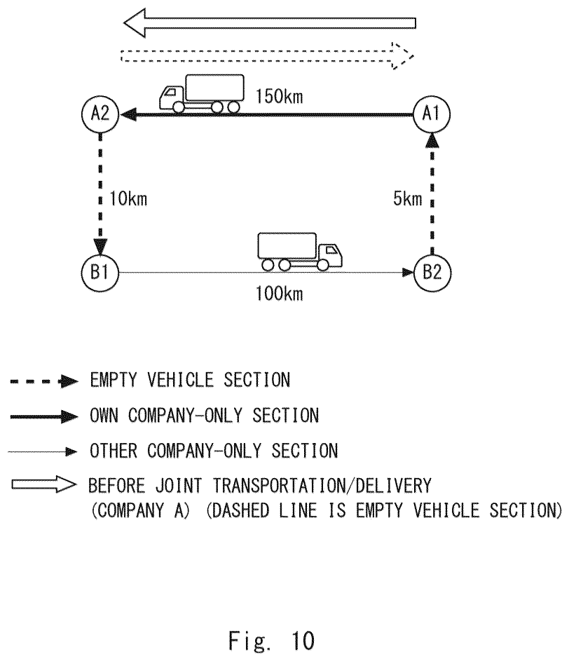

Next, a specific calculation example will be described with reference to FIGS. 9 and 10. FIG. 9 is a calculation example in a case where the joint transportation/delivery by consolidation service is performed. FIG. 10 is a calculation example in a case where the joint transportation/delivery by round transportation is performed. Hereinafter, the first shipping provider who is entrusted with the joint transportation/delivery will be described as a company A, and the second shipping provider who outsources the joint transportation/delivery will be described as a company B.

### Specific Example of Consolidation Service

First, with reference to FIG. 9, a calculation example in a case where the joint transportation/delivery by consolidation service is performed will be described. A white arrow in FIG. 9 indicates movement of the company A's vehicle before the joint transportation/delivery is performed (in a state where the joint transportation/delivery is not performed). As indicated by the white arrow, before the joint transportation/delivery is performed, the company A's vehicle loads the company A's cargo, moves from A1 to A2, and brings the company A's cargo to A2. Although an arrow indicating the movement of the company B's vehicle in this case is not illustrated, the company B's vehicle loads the company B's cargo, moves from B1 to B2, and brings the company B's cargo into B2.

Arrows other than the white arrow are similar to those described above. The movement of the company A's vehicle after the joint transportation/delivery (in a state where the joint transportation/delivery is performed) indicated by the arrows other than the white arrow is relevant to the case of (1) in FIG. 5. The company A performs the joint transportation/delivery with A1 as a departure place, via B1 and B2, and with A2 as an arrival place. First, the company A's vehicle loads the company A's cargo, moves from A1 to B1, and picks up the company B's cargo at B1. Subsequently, the company A's vehicle loads the cargos of the company A and the company B, moves from B1 to B2, and brings the cargo of the company B into B2. Then, the company A's vehicle loads only the cargo of the company A, moves from B2 to A2, and brings the cargo of the company A into A2.

Assuming that the loading rates of the cargos in the company A's vehicle and the company B's vehicle are Ra and Rb, and the information (loading capacity) of the ton vehicles of the company A's vehicle and the company B's vehicle is Ta and Tb, the loading amount of the cargo in each section is expressed as follows.

$$Own company - only section : ( loading rate Ra \times Ta - ton vehicle )$$

$$Mixed loading section : ( loading rate Ra \times Ta - ton vehicle + loading rate Rb \times Tb - ton vehicle )$$

$$Other company - only section : ( loading rate Rb \times Tb - ton vehicle )$$

Hereinafter, it is assumed that the loading rate Ra of the company A's vehicle is 40%, the ton vehicle Ta of the company A's vehicle is 10 ton-vehicle, the loading rate Rb of the company B's vehicle is 60%, and the ton vehicle Tb of the company B's vehicle is 10 ton-vehicle.

As shown in Expression (1), the carbon dioxide emission can be approximated by “Weight of cargo×travel distance×(Improved ton kilometer method fuel consumption basic unit (L/(t·km))×carbon dioxide emission coefficient× 1/1000)”. Here, in a case where “(Improved ton kilometer method fuel consumption basic unit (L/(t·km))×carbon dioxide emission coefficient × 1/1000)” is a constant X, the carbon dioxide emission can be expressed by the following Expression (3).

$$Carbon dioxide emission \approx weight of cargo \times travel distance \times constant X \qquad Expression ( 3 )$$

Based on the above conditions, the calculation results before and after the company A's vehicle performs the joint transportation/delivery on the travel route illustrated in FIG. 9 are as follows.

### Before Joint Transportation/Delivery

Company A-only section
Travel distance (A1→A2): 150 km
Weight of cargo: loading rate 40% ×10-ton vehicle≈4 t

$$Carbon dioxide : 0.4 \times 10 tons \times 150 km \times X = 6 \; 00 X \qquad < 1 >$$

Company B-only section
Travel distance (B1→B2): 100 km
Weight of cargo: loading rate 60%×10-ton vehicle≈6 t

$$Carbon dioxide : 0.6 \times 10 tons \times 100 km \times X = 6 \; 00 X \qquad < 2 >$$

Total carbon dioxide emissions before joint transportation/delivery

$$< 1 > + < 2 > = 12 \; 00 X \qquad ( i )$$

### After Joint Transportation/Delivery

It is assumed that the company A's vehicle has moved along a route of

$$A 1 \to B 1 \to B 2 \to A 2 .$$

Company A-only section 1 (A1→B1)
Travel distance (A1→B1): 10 km
Weight of cargo: loading rate 40% ×10-ton vehicle≈4 t

$$Carbon dioxide : 0.4 \times 10 tons \times 10 km \times X = 40 X \qquad < 3 >$$

Mixed loading section of the company A and the company B (B1→B2)
Travel distance (B1→B2): 100 km
Weight of cargo: loading rate 40%×10-ton vehicle+loading rate 60%×10-ton vehicle=10 t

$$Carbon dioxide : ( 4 + 6 ) \times 100 \times X = 10 \; 00 X \qquad < 4 >$$

Company A-only section 2 (B2→A2)
Travel distance (B2→A2): 5 km
Weight of cargo: loading rate 40%×10-ton vehicle≈4 t

$$Carbon dioxide : 0.4 \times 10 tons \times 5 km \times X = 20 X \qquad < 5 >$$

Total carbon dioxide emissions after joint transportation/delivery

$$< 3 > + < 4 > + < 5 > = 10 \; 60 X \qquad ( ii )$$

Amount of carbon dioxide reduction before and after joint transportation/delivery

$$( i ) - ( i i ) = 1200 X - 1060 X = 1 \; 40 X \qquad ( iii )$$

Proportional amount of carbon dioxide reduction

$$Proportional distribution coefficient = weight of own company ’ s cargo \text{} / ( weight of own company ’ s cargo + weight of partner ’ s cargo )$$

$$Carbon dioxide reduction amount of the company A = ( iii ) \times proportional distribution coefficient = 140 X \times ( 4 / ( 4 + 6 ) ) = 56 X$$

$$Carbon dioxide reduction amount of the company B = ( iii ) \times proportional distribution coefficient = 140 X \times ( 6 / ( 4 + 6 ) ) = 84 X$$

### Specific Example of Round Transportation

Next, a calculation example in a case where the joint transportation/delivery by round transportation is performed will be described with reference to FIG. 10. A white arrow in FIG. 10 indicates movement of the company A before the joint transportation/delivery is performed (in a state where the joint transportation/delivery is not performed), and a white arrow indicated by a broken line indicates an empty vehicle section.

Before the joint transportation/delivery is performed, the company A's vehicle loads the company A's cargo, moves from A1 to A2, and brings the company A's cargo to A2. The company A's vehicle returns from A2 to A1 in an empty state. Although an arrow indicating the movement of the company B's vehicle in this case is not illustrated, the company B's vehicle loads the company B's cargo, moves from B1 to B2, and brings the company B's cargo into B2. The company B's vehicle returns from B2 to B1 in an empty state.

Arrows other than the white arrow are similar to those described above. The movement of the company A's vehicle after the joint transportation/delivery (in a state where the joint transportation/delivery is performed) indicated by arrows other than the white arrow is relevant to the case of FIG. 6 although the arrangement of the bases is different. The company A performs the joint transportation/delivery with A1 as a departure place, via A2, B1, and B2, and with A2 as an arrival place. First, the company A's vehicle loads the company A's cargo, moves from A1 to A2, and brings the company A's cargo into A2. Next, the company A's vehicle moves from A2 to B1 in an empty state, and picks up the company B's cargo at B1. Subsequently, the company A's vehicle loads only the company B's cargo, moves from B1 to B2, and brings the company B's cargo into B2. Then, the company A's vehicle returns to A1 in an empty state.

In the case of round transportation, the fuel consumption method is used as a carbon dioxide emission method. In the case of the fuel consumption method, the weight of the cargo is irrelevant to the carbon dioxide emission amount. The carbon dioxide emission in a case where the fuel consumption method is used can be expressed by the following Expression (4).

$$Carbon dioxide emission \approx travel distance \times constant Y \qquad Expression ( 4 )$$

The constant Y is “1/fuel consumption (km/L)×carbon dioxide emission coefficient× 1/1000”.

Based on the above conditions, the calculation results before and after the company A's vehicle performs the joint transportation/delivery on the travel route illustrated in FIG. 10 are as follows.

### Before Joint Transportation/Delivery

Company A-only section
Travel distance (A1→A2→A1): 300 km

$$Carbon dioxide : 300 km \times Y = 3 \; 00 Y \qquad < 1 >$$

Company B-only section
Travel distance (B1→B2→B1): 200 km

$$Carbon dioxide : 200 km \times Y = 2 \; 00 Y \qquad < 2 >$$

Total carbon dioxide emissions before joint transportation/delivery

$$< 1 > + < 2 > = 5 \; 00 Y \qquad ( i )$$

### After Joint Transportation/Delivery

It is assumed that the company A's vehicle has moved along a route of

$$A 1 \to A 2 \to B 1 \to B 2 \to A 1 .$$

Company A-only section 1 (A1→A2)
Travel distance (A1→A2): 150 km

$$Carbon dioxide : 150 km \times Y = 1 \; 50 Y \qquad < 3 >$$

Empty vehicle section (A2→B1)
Travel distance (A2→B1): 10 km

$$Carbon dioxide : 10 km \times Y = 10 Y \qquad < 4 >$$

Company B-only section (B1→B2)
Travel distance (B1→B2): 100 km

$$Carbon dioxide : 100 km \times Y = 1 \; 00 Y \qquad < 5 >$$

Empty vehicle section (B2→A1)
Travel distance (B2→A1): 5 km

$$Carbon dioxide : 5 km \times Y = 5 Y \qquad < 6 >$$

Total carbon dioxide emissions after joint transportation/delivery

$$< 3 > + < 4 > + < 5 > + < 6 >= 265 Y \qquad ( ii )$$

Amount of carbon dioxide reduction before and after joint transportation/delivery

$$( i ) - ( i i ) = 500 Y - 265 Y = 235 Y \qquad ( iii )$$

Proportional amount of carbon dioxide reduction

$$Proportional distribution coefficient = weight of own company ’ s cargo \text{} / ( weight of own company ’ s cargo + weight of partner ’ s cargo )$$

$$Carbon dioxide reduction amount of the company A = ( iii ) \times proportional distribution coefficient = 235 Y \times ( 4 / ( 4 + 6 ) ) = 94 Y$$

$$Carbon dioxide reduction amount of the company B = ( iii ) \times proportional distribution coefficient = 235 Y \times ( 6 / ( 4 + 6 ) ) = 141 Y$$

As described above, according to the information processing system 50 according to the present disclosure, the information processing device 10 acquires form information regarding a form of the joint transportation/delivery, and acquires information regarding a carbon dioxide emission estimated based on the transportation/delivery condition including the form information. With such a configuration, the information processing device 10 can accurately estimate the carbon dioxide emission in the joint transportation/delivery.

The information processing device 10 can appropriately calculate the amount of carbon dioxide for each shipping provider by multiplying the carbon dioxide emission by a proportional distribution coefficient based on the weight of the cargo and the travel distance. For example, in a case where the joint transportation/delivery is performed, in a case where one shipping provider is viewed alone, it appears that the carbon dioxide emission increases due to an extension of the travel distance (transportation/delivery to the counterpart base), an increase in the weight of the cargo (weight of the cargo of the counterpart), and the like. However, by performing the process according to the present disclosure, the information processing system 50 can confirm that carbon dioxide has been reduced from the viewpoint of the entire plurality of shipping providers who perform the joint transportation/delivery. In this way, the information processing system 50 can quantitatively determine which pattern of the joint transportation/delivery is effective in reducing carbon dioxide emissions.

### Configuration Example of Hardware

Each functional configuration unit of the information processing device 100, the information processing device 10, the terminal device 20, and the estimation device 30 (hereinafter referred to as “information processing device 100 and the like”) may be implemented by hardware (for example, a hard-wired electronic circuit or the like) that implements each functional component, or may be achieved by a combination of hardware and software (for example, a combination of an electronic circuit and a program that controls the electronic circuit, or the like). Hereinafter, a case will be described in which each functional configuration unit of the information processing device 100 and the like is achieved by a combination of hardware and software.

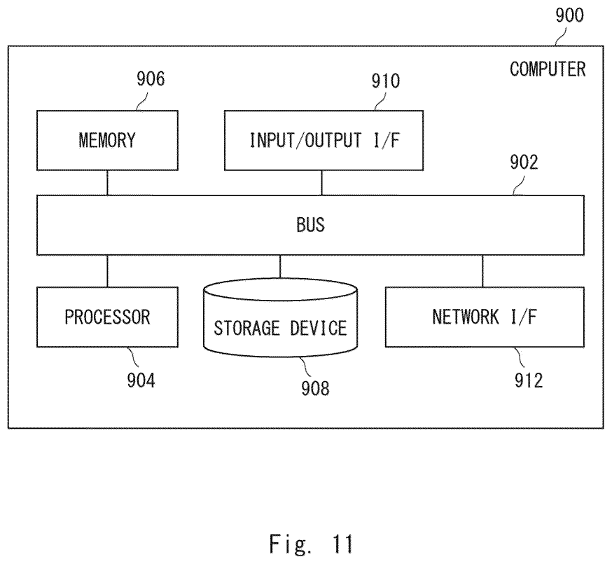

FIG. 11 is a block diagram exemplifying a hardware configuration of a computer 900 that implements the information processing device 100 and the like. The computer 900 may be a dedicated computer designed to implement the information processing device 100 and the like, or may be a general-purpose computer. The computer 900 may be a portable computer, such as a smartphone, a tablet terminal, or the like.

For example, by installing a predetermined application in the computer 900, each function of the information processing device 100 and the like is implemented in the computer 900. The application mentioned above includes programs for implementing the functional configuration units of the information processing device 100 and the like.

The computer 900 includes a bus 902, a processor 904, a memory 906, a storage device 908, an input/output interface 910, and a network interface 912. The bus 902 is a data transmission path through which the processor 904, the memory 906, the storage device 908, the input/output interface 910, and the network interface 912 mutually exchange data. However, a method for connecting the processor 904 and the like to each other is not limited to the bus connection.

The processor 904 is various such as a central processing unit (CPU), a graphics processing unit (GPU), a field-programmable gate array (FPGA), or a quantum processor (quantum computer control chip). The memory 906 is a main storage device implemented using a random access memory (RAM) or the like. The storage device 908 is an auxiliary storage device implemented using a hard disk, a solid state drive (SSD), a memory card, a read only memory (ROM), or the like.

The input/output interface 910 is an interface for connecting the computer 900 with an input/output device. For example, an input device such as a keyboard and an output device such as a display device are connected to the input/output interface 910.

The network interface 912 is an interface for connecting the computer 900 to a network. The network may be a local area network (LAN) or a wide area network (WAN).

The storage device 908 stores the programs for implementing the functional configuration units of the information processing device 100 and the like (programs for implementing the application mentioned above). The processor 904 reads the programs into the memory 906 and executes them, thereby implementing the functional configuration units of the information processing device 100 and the like.

Each of the processors executes one or more programs including commands for causing the computer to execute the algorithm described with reference to the drawings. The program includes commands (or software codes) for causing the computer to implement one or more functions described in the example embodiments in a case of being read by the computer. The program may be stored in various types of non-transitory computer-readable media or tangible storage media. By way of example, and not limitation, non-transitory computer-readable media or tangible storage media include RAM, ROM, flash memory, SSD or other memory technology, CD-ROM, digital versatile disc (DVD), Blu-ray® disk or other optical disk storage, magnetic cassettes, magnetic tape, magnetic disk storage, or other magnetic storage devices. The program may also be transmitted in the various types of transitory computer-readable media or a communication medium. As an example and not by way of limitation, the transitory computer-readable medium or communication medium includes electric, optical, acoustic, or any other form of propagation signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above example embodiments may also be described as the following Supplementary Notes, but are not limited to the following.

### Supplementary Note 1

An information processing device including:
a transportation/delivery information acquisition unit that acquires first transportation/delivery information regarding transportation/delivery of a first shipping provider who is entrusted with joint transportation/delivery and second transportation/delivery information regarding transportation/delivery of a second shipping provider who outsources the joint transportation/delivery;
a form information acquisition unit that acquires form information regarding a form of the joint transportation/delivery;
a transportation/delivery condition output unit that outputs a transportation/delivery condition including the first transportation/delivery information, the second transportation/delivery information, and the form information;
an emission information acquisition unit that acquires first emission information regarding a carbon dioxide emission of the first shipping provider and second emission information regarding a carbon dioxide emission of the second shipping provider, the first emission information and the second emission information being estimated based on the transportation/delivery condition; and
a provision information output unit that outputs provision information based on the first and second emission information.

### Supplementary Note 2

The information processing device according to Supplementary Note 1, in which the form information acquisition unit acquires a form of the joint transportation/delivery designated by the first or second shipping provider as the form information in a joint transportation/delivery system that adjusts the joint transportation/delivery between shipping providers.

### Supplementary Note 3

The information processing device according to Supplementary Note 1 or 2, further including a difference calculation unit that acquires first record information indicating a record for the estimated first emission information and second record information indicating a record for the estimated second emission information after execution of the joint transportation/delivery, and calculates a difference by comparing an estimated value with a record value.

### Supplementary Note 4

The information processing device according to Supplementary Note 3, in which performing relearning of an estimation model for estimating the first and second emission information is performed by using the calculated difference.

### Supplementary Note 5

The information processing device according to any one of Supplementary Notes 1 to 4, in which
the emission information acquisition unit further acquires third emission information regarding a carbon dioxide emission of the first shipping provider and fourth emission information regarding a carbon dioxide emission of the second shipping provider in a case where the joint transportation/delivery is not performed,
the information processing device further includes a reduction amount estimation unit that estimates, based on the first to fourth emission information, an emission reduction amount that is a difference between a carbon dioxide emission in a case where the joint transportation/delivery is performed and a carbon dioxide emission in a case where the joint transportation/delivery is not performed, and
the provision information output unit outputs the provision information including the emission reduction amount.

### Supplementary Note 6

The information processing device according to Supplementary Note 5, in which
the reduction amount estimation unit estimates the emission reduction amount of each of a plurality of candidate shipping providers in a case where there is a plurality of candidate shipping providers who are candidates of the first or second shipping provider, and
the provision information output unit rearranges and outputs the candidate shipping providers based on the emission reduction amount.

### Supplementary Note 7

The information processing device according to any one of Supplementary Notes 1 to 6, in which
the first transportation/delivery information includes first departure and arrival information which is a departure and arrival place of the first shipping provider,
the second transportation/delivery information includes second departure and arrival information which is a departure and arrival place of the second shipping provider, and
the form information includes information on a transportation/delivery method between the first departure and arrival place and the second departure and arrival place.

### Supplementary Note 8

The information processing device according to Supplementary Note 7, in which the form information further includes information on a cargo pickup method and a cargo delivery method at each of the first and second departure and arrival places.

### Supplementary Note 9

An information processing method including:
a transportation/delivery information acquisition step of acquiring first transportation/delivery information regarding transportation/delivery of a first shipping provider who is entrusted with joint transportation/delivery and second transportation/delivery information regarding transportation/delivery of a second shipping provider who outsources the joint transportation/delivery;
a form information acquisition step of acquiring form information regarding a form of the joint transportation/delivery;
a transportation/delivery condition output step of outputting a transportation/delivery condition including the first transportation/delivery information, the second transportation/delivery information, and the form information;
an emission information acquisition step of acquiring first emission information regarding a carbon dioxide emission of the first shipping provider and second emission information regarding a carbon dioxide emission of the second shipping provider, the first emission information and the second emission information being estimated based on the transportation/delivery condition; and
a provision information output step of outputting provision information based on the first and second emission information.

### Supplementary Note 10

A program for causing a computer to execute:
a transportation/delivery information acquisition step of acquiring first transportation/delivery information regarding transportation/delivery of a first shipping provider who is entrusted with joint transportation/delivery and second transportation/delivery information regarding transportation/delivery of a second shipping provider who outsources the joint transportation/delivery;
a form information acquisition step of acquiring form information regarding a form of the joint transportation/delivery;
a transportation/delivery condition output step of outputting a transportation/delivery condition including the first transportation/delivery information, the second transportation/delivery information, and the form information;
an emission information acquisition step of acquiring first emission information regarding a carbon dioxide emission of the first shipping provider and second emission information regarding a carbon dioxide emission of the second shipping provider, the first emission information and the second emission information being estimated based on the transportation/delivery condition; and
a provision information output step of outputting provision information based on the first and second emission information.

Some or all of the elements (for example, configurations and functions) described in Supplementary Notes 2 to 8 dependent on Supplementary Note 1 can also depend on Supplementary Notes 9 and 10 in a similar dependency relationship as Supplementary Notes 2 to 8. Some or all of the elements that have been described in any Supplementary Note are applicable to various types of hardware, software, recording means for recording software, systems, and methods.

What is claimed is:

1. An information processing device comprising:
at least one memory storing instructions; and
at least one processor configured to execute the instructions to:
acquire first transportation/delivery information regarding transportation/delivery of a first shipping provider who is entrusted with joint transportation/delivery and second transportation/delivery information regarding transportation/delivery of a second shipping provider who outsources the joint transportation/delivery;
acquire form information regarding a form of the joint transportation/delivery;
output a transportation/delivery condition including the first transportation/delivery information, the second transportation/delivery information, and the form information;
acquire first emission information regarding a carbon dioxide emission of the first shipping provider and second emission information regarding a carbon dioxide emission of the second shipping provider, the first emission information and the second emission information being estimated based on the transportation/delivery condition; and
output provision information based on the first and second emission information.

2. The information processing device according to claim 1, wherein the at least one processor is further configured to execute the instructions to acquire a form of the joint transportation/delivery designated by the first or second shipping provider as the form information in a joint transportation/delivery system that adjusts the joint transportation/delivery between shipping providers.

3. The information processing device according to claim 1, wherein the at least one processor is further configured to execute the instructions to acquire first record information indicating a record for the estimated first emission information and second record information indicating a record for the estimated second emission information after execution of the joint transportation/delivery, and calculate a difference by comparing an estimated value with a record value.

4. The information processing device according to claim 3, wherein the at least one processor is further configured to execute the instructions to perform relearning of an estimation model for estimating the first and second emission information by using the calculated difference.

5. The information processing device according to claim 1,
wherein the at least one processor is further configured to execute the instructions to:
further acquire third emission information regarding a carbon dioxide emission of the first shipping provider and fourth emission information regarding a carbon dioxide emission of the second shipping provider in a case where the joint transportation/delivery is not performed;
estimate, based on the first to fourth emission information, an emission reduction amount that is a difference between a carbon dioxide emission in a case where the joint transportation/delivery is performed and a carbon dioxide emission in a case where the joint transportation/delivery is not performed; and
output the provision information including the emission reduction amount.

6. The information processing device according to claim 5,
wherein the at least one processor is further configured to execute the instructions to:
estimate the emission reduction amount of each of a plurality of candidate shipping providers in a case where there is a plurality of candidate shipping providers who are candidates of the first or second shipping provider; and
rearrange and output the candidate shipping providers based on the emission reduction amount.

7. The information processing device according to claim 1, wherein
the first transportation/delivery information includes first departure and arrival information which is a departure and arrival place of the first shipping provider,
the second transportation/delivery information includes second departure and arrival information which is a departure and arrival place of the second shipping provider, and
the form information includes information on a transportation/delivery method between the first departure and arrival place and the second departure and arrival place.

8. The information processing device according to claim 7, wherein the form information further includes information on a cargo pickup method and a cargo delivery method at each of the first and second departure and arrival places.

9. An information processing method comprising:
a transportation/delivery information acquisition step of acquiring first transportation/delivery information regarding transportation/delivery of a first shipping provider who is entrusted with joint transportation/delivery and second transportation/delivery information regarding transportation/delivery of a second shipping provider who outsources the joint transportation/delivery;
a form information acquisition step of acquiring form information regarding a form of the joint transportation/delivery;
a transportation/delivery condition output step of outputting a transportation/delivery condition including the first transportation/delivery information, the second transportation/delivery information, and the form information;
an emission information acquisition step of acquiring first emission information regarding a carbon dioxide emission of the first shipping provider and second emission information regarding a carbon dioxide emission of the second shipping provider, the first emission information and the second emission information being estimated based on the transportation/delivery condition; and
a provision information output step of outputting provision information based on the first and second emission information.

10. A non-transitory computer readable medium having stored therein a program for causing a computer to execute:
a transportation/delivery information acquisition step of acquiring first transportation/delivery information regarding transportation/delivery of a first shipping provider who is entrusted with joint transportation/delivery and second transportation/delivery information regarding transportation/delivery of a second shipping provider who outsources the joint transportation/delivery;
a form information acquisition step of acquiring form information regarding a form of the joint transportation/delivery;
a transportation/delivery condition output step of outputting a transportation/delivery condition including the first transportation/delivery information, the second transportation/delivery information, and the form information;
an emission information acquisition step of acquiring first emission information regarding a carbon dioxide emission of the first shipping provider and second emission information regarding a carbon dioxide emission of the second shipping provider, the first emission information and the second emission information being estimated based on the transportation/delivery condition; and
a provision information output step of outputting provision information based on the first and second emission information.
